(19) United States
(12) Patent Application Publication
(10) Pub. No.: US 2013/0326202 A1
(43) Pub. Date: Dec. 5, 2013

(54) LOAD TEST CAPACITY PLANNING

(71) Applicants: Roi Rosenthal, Oranit (IL); Nir Hemed, Yehud (IL); Leonid Pekel, (US); Adi Kidron, Ganei Tikva (IL); Yair Horovitz, Mazkeret Batya (IL)

(72) Inventors: Roi Rosenthal, Oranit (IL); Nir Hemed, Yehud (IL); Leonid Pekel, (US); Adi Kidron, Ganei Tikva (IL); Yair Horovitz, Mazkeret Batya (IL)

(21) Appl. No.: 13/483,755

(22) Filed: May 30, 2012

(51) Int. Cl. G06F 9/30

(52) U.S. Cl. 712/227; 712/E09.032

(57) ABSTRACT

Disclosed herein are techniques for load test capacity planning. Resources consumed by instructions executing in a first computer apparatus are determined. A metric associated with a second computer apparatus is determined. A number of instances of the instructions that are able to execute concurrently in the second computer apparatus is determined.

### BACKGROUND

Engineers use load testing to evaluate the performance of a computer program while being exposed to a heavy workload. Load testing is one of the tests carried out before a software application is shipped to customers. A test engineer may attempt to understand how a human user would interact with the software application and devise a test plan to automate the human interaction therewith. Such automation may be conducted with a software testing tool, such as LoadRunner distributed by Hewlett-Packard.

A test engineer may use a software testing tool to interact with a computer program and record those interactions in a script. Such a script may be replayed as many times as needed to evaluate the performance of the program. During load testing, test engineers may execute multiple concurrent instances of these scripts to determine how the program reacts under stress.

### BRIEF DESCRIPTION OF THE DRAWINGS

FIG. 1 is a block diagram of an example computer apparatus for enabling the test script generation techniques disclosed herein.

FIG. 2 is an example screen shot in accordance with aspects of the present disclosure.

FIG. 3 is a flow diagram of an example method in accordance with aspects of the present disclosure.

FIG. 4 is a working example of a script's execution in a computer apparatus in accordance with aspects of the present disclosure.

FIG. 5 is a further example of a screen shot in accordance with aspects of the present disclosure.

### DETAILED DESCRIPTION

Introduction:

As noted above, a load test may include concurrent execution of multiple scripts to evaluate the performance of a computer program. Load tests may be implemented in a lab containing a plurality of load generators, which are computer apparatus used for executing the scripts. The cost to purchase these computers depend on the load testing plan or the scenarios that will be evaluated. However, when formulating a particular test plan, estimating the number of computers to purchase may be difficult. Furthermore, there are many types of computer apparatus in the market with different specifications. An inaccurate estimate may result in the purchase of too many or too few computers for a given load test or may result in the purchase of unsuitable computer hardware. If unsuitable hardware is purchased, the processor thereof may be overly consumed during the test, which may result in inaccurate measurements, such as invalid response times of the user simulations. Manually forecasting the amount and type of resources to purchase for a particular load test may be burdensome and time consuming.

In view of the foregoing, various examples disclosed herein provide a system, non-transitory computer-readable medium, and method that may provide test engineers with forecast information which allows them to appropriately budget for a particular load test. For example, the techniques herein may advise a test engineer how many scripts associated with a load test can execute concurrently in a particular computer apparatus. Such a forecast may be based at least partially from a metric associated with a different computer apparatus. The aspects, features and advantages of the present disclosure will be appreciated when considered with reference to the following description of examples and accompanying figures. The following description does not limit the application; rather, the scope of the disclosure is defined by the appended claims and equivalents. The present disclosure is divided into sections. The first, labeled “Components,” describes examples of various physical and logical components for implementing aspects of the disclosure. The second section, labeled “Operation,” provides a working example of the computer apparatus, non-transitory computer-readable medium, and method. Finally, the section labeled “Conclusion” summarizes the disclosure.

Components:

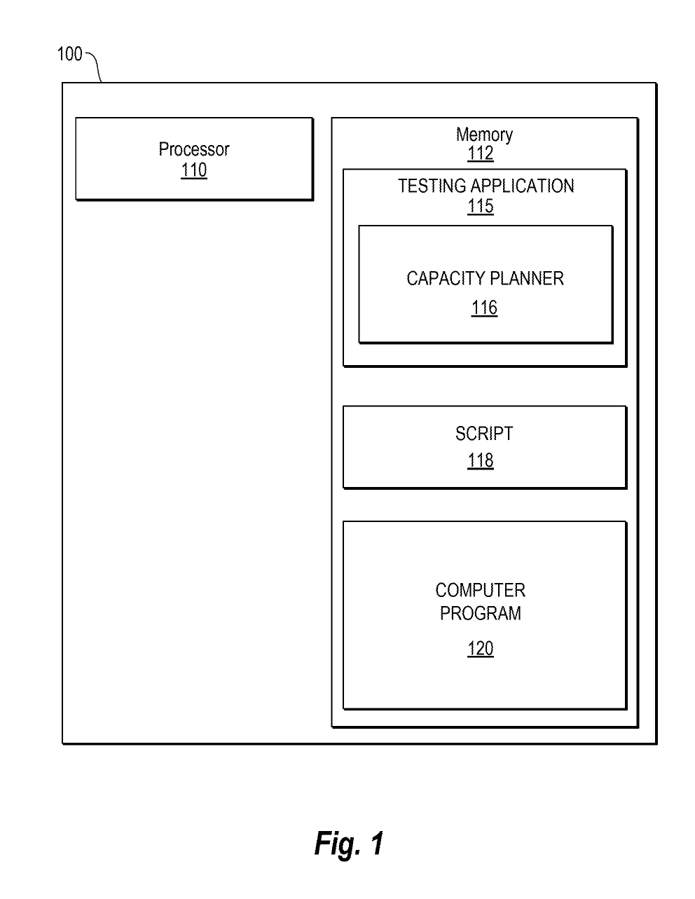

FIG. 1 presents a schematic diagram of an illustrative computer apparatus 100 depicting various components in accordance with aspects of the present disclosure. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. As will be shown further below, computer apparatus 100 may also comprise a network interface to communicate with other devices over a network using conventional protocols (e.g., Ethernet, Wi-Fi, Bluetooth, etc.).

The computer apparatus 100 may also contain a processor 110 and memory 112. Memory 112 may store instructions that may be retrieved and executed by processor 110. In one example, memory 112 may be a random access memory (“RAM”) device. In a further example, memory 112 may be divided into multiple memory segments organized as dual in-line memory modules (DIMMs). Alternatively, memory 112 may comprise other types of devices, such as memory provided on floppy disk drives, tapes, and hard disk drives, or other storage devices that may be coupled to computer apparatus 100 directly or indirectly. The memory may also include any combination of one or more of the foregoing and/or other devices as well. The processor 110 may be any number of well known processors, such as processors from Intel® Corporation. In another example, the processor may be a dedicated controller for executing operations, such as an application specific integrated circuit (“ASIC”). Although all the components of computer apparatus 100 are functionally illustrated in FIG. 1 as being within the same block, it will be understood that the components may or may not be stored within the same physical housing. Furthermore, computer apparatus 100 may actually comprise multiple processors and memories working in tandem.

The instructions residing in memory 112 may comprise any set of instructions to be executed directly (such as machine code) or indirectly (such as scripts) by processor 110. In that regard, the terms “instructions,” “scripts,” “applications,” and “programs” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

Testing application 115 may contain a capacity planner module 116 that may implement the techniques described in the present disclosure. In that regard, testing application 115 may be realized in any non-transitory computer-readable media for use by or in connection with an instruction execution system such as computer apparatus 100, an ASIC or other system that can fetch or obtain the logic from non-transitory computer-readable media and execute the instructions contained therein. “Non-transitory computer-readable media” may be any media that can contain, store, or maintain programs and data for use by or in connection with the instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, or a portable compact disc.

Testing application 115 may configure processor 110 to record human interactions with a program being subjected to load testing, such as computer program 120. These interactions may be recorded as a series of functions in script 118, which may be executable by testing application 115. The recorded functions may trigger the same objects in the program being tested that were triggered during the recording. Testing application 115 may be any performance and load testing application for examining system behavior and performance while generating actual workload. One example of such application is the LoadRunner application distributed by Hewlett-Packard. However, it is understood that any appropriate network or load monitoring tool may be used and is considered to be within the scope of the present disclosure. In some implementations, LoadRunner or other load test application may execute concurrent instances of a script, such as script 118, to emulate hundreds or thousands of concurrent users and/or transactions. During such a load test, test engineers may be able to collect information from infrastructure components.

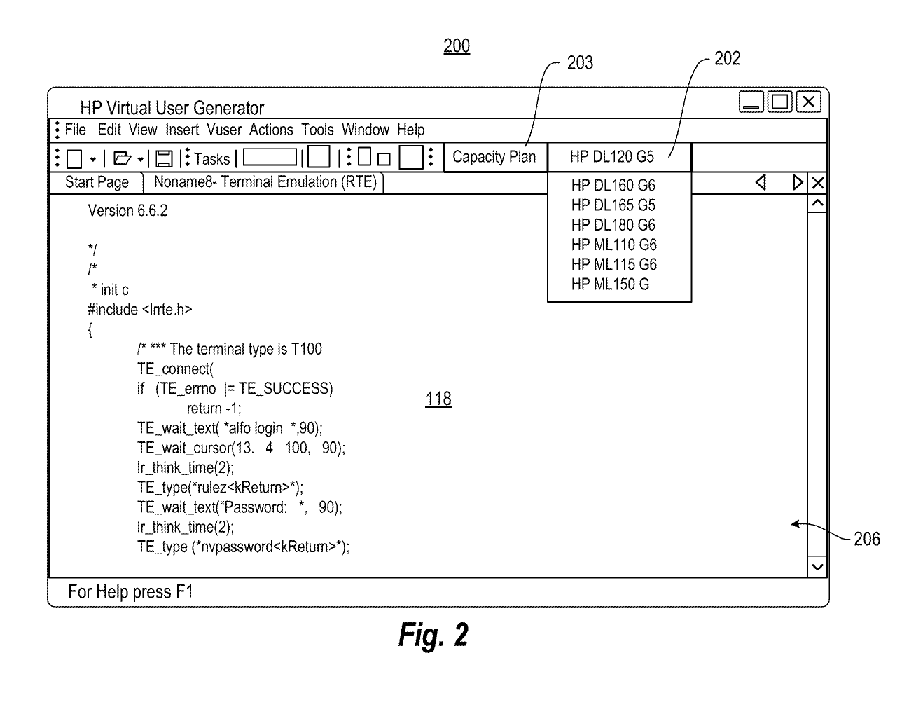

FIG. 2 shows an illustrative interface screen shot 200 that may allow a user to launch the capacity planner module 116. In the screen shot of FIG. 2, the user may launch the module by clicking on capacity plan button 203. By way of example, capacity plan button 203 may be included in the virtual user generator screen provided by Hewlett-Packard's LoadRunner application. The illustrative screen shot 200 also shows script 118 in window 206. As noted above, script 118 may contain recorded user interactions with a program being tested. Interface screen shot 200 may also include a drop down box 202 containing a list of different computer apparatus models. A test engineer may select a computer apparatus model from drop down box 202, and capacity planner module 116 may supply the engineer with an estimate of concurrent instances of script 118 capable of executing in the selected computer apparatus. As will be discussed further below, metric information associated with a selected computer apparatus may be imported from a benchmark standard-setting entity, such as www.spec.org or community forums. In another example, the test engineer may want a capacity plan estimate associated with his or her local computer, such as computer apparatus 100. If the test engineer desires such an estimate, an option in drop down box 202 may be provided that permits the user to select the local computer. In this example, no metric information would need to be downloaded from a benchmark standard-setting entity. Instead, the metric information could be determined in the local computer.

Operation:

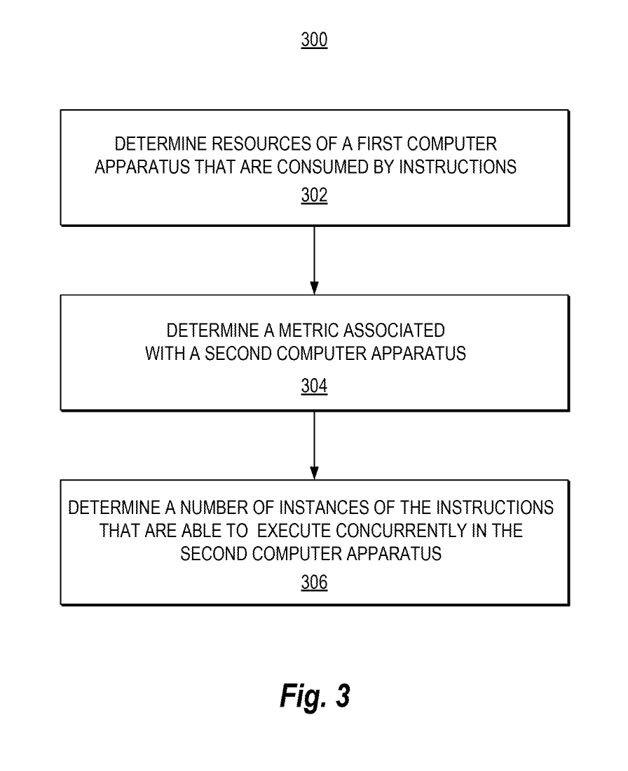

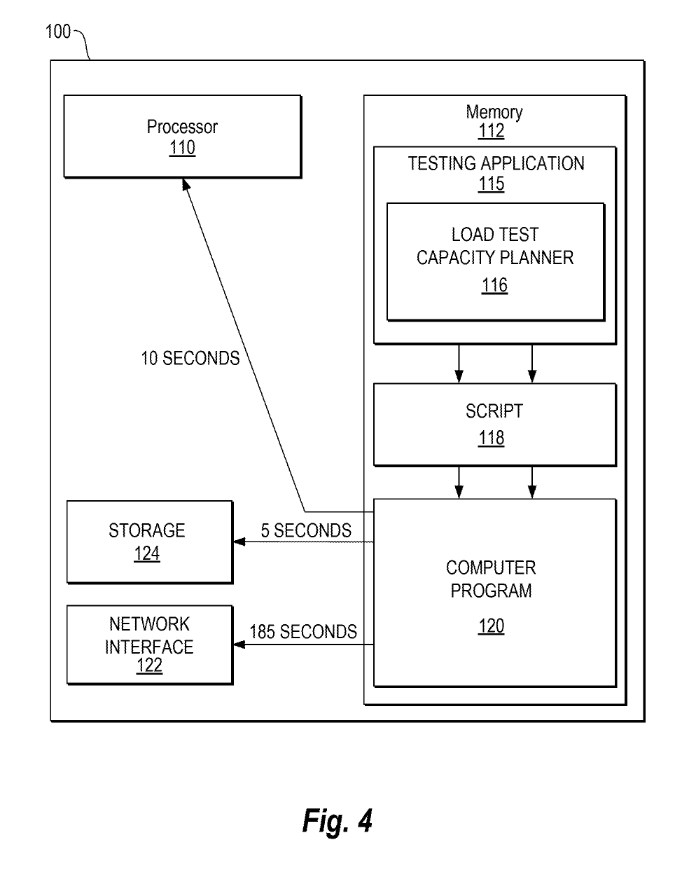

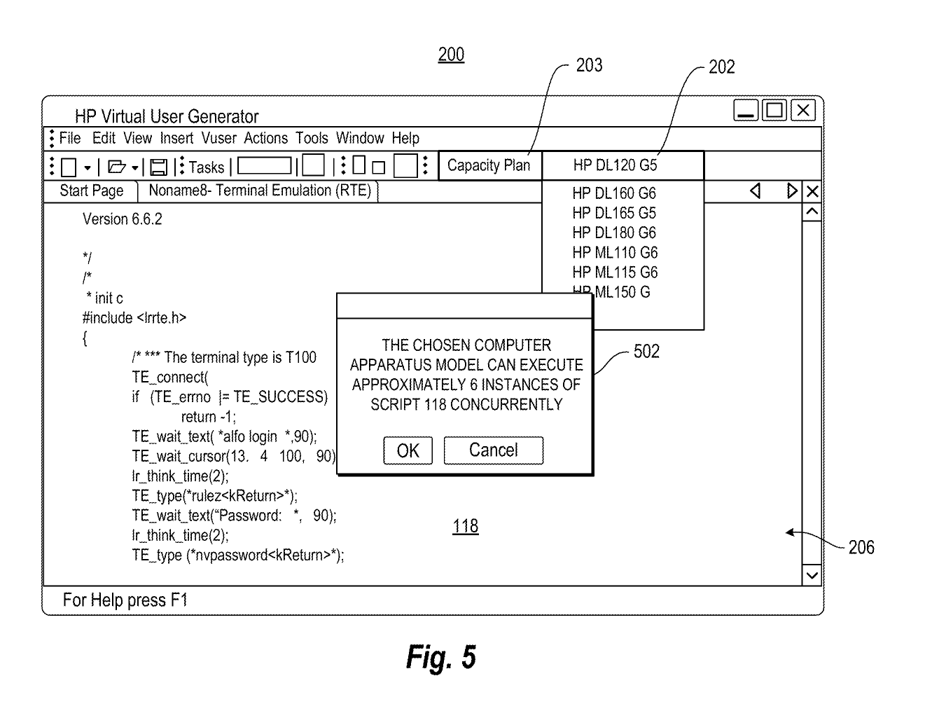

One working example of the system, method, and non-transitory computer-readable medium is shown in FIGS. 3-5. In particular, FIG. 3 illustrates a flow diagram of an example method for load test capacity planning in accordance with aspects of the present disclosure. FIGS. 4-5 show a working example of load test capacity planning in accordance with aspects of the present disclosure. The actions shown in FIGS. 4-5 will be discussed below with regard to the flow diagram of FIG. 3.

In FIG. 3, resources of a first computer apparatus that are consumed by computer executable instructions may be determined, as shown in block 302. In one example, the first computer apparatus may be the computer executing the capacity planner module 116, such as computer apparatus 100. The computer executable instructions may be a script that simulates a user interacting with a computer program, such as script 118. In another example, the resources of the first computer apparatus that are consumed by the script may be partially determined based on a metric associated with the first computer apparatus. The metric associated with the first computer apparatus may be a standard benchmark number divided by a machine benchmark number. The machine benchmark number may be a length of time that the processor of the first computer apparatus takes to execute a benchmark program. The benchmark program may be any pre-selected program that tests relevant resources of a given computer apparatus. For example, computer apparatus 100 of FIG. 1 may have taken 22 seconds to execute the benchmark program. The standard benchmark number may be any number deemed as the industry standard. In one example, the standard benchmark number is one thousand points. Thus 1000 points/22 seconds provides a metric of 45 points/second for computer apparatus 100.

The resources of the first computer apparatus consumed by the script may be further determined by executing the script in the first computer apparatus. Referring now to FIG. 4, a working example of a script executing in computer apparatus 100 is shown. Script 118 may be executed once in computer apparatus 100 to determine a script processor number and a script runtime number. The script processor number may be the time spent by a script using the processor of the first computer apparatus. In the example of FIG. 4, script 118 used processor 110 for 10 seconds. Thus, the script processor number for the example in FIG. 4 is 10 seconds. The script runtime number may be the length of time the script takes to complete execution in the first computer apparatus. In the example of FIG. 4, script 118 uses processor 110 for 10 seconds, storage device 124 for 5 seconds, and network interface 122 for 185 seconds. In total, the script took 200 seconds to complete execution in computer apparatus 100. Thus, the script runtime number for the example of FIG. 4 is 200 seconds. The script runtime number may be adjusted in accordance with delay patterns encoded in script 118. A delay pattern may be any idle time recorded in the script that simulates a user being idle while interacting with a computer program. Such delay patterns may be inserted in the script to simulate slow user response time or fast user response time. The script runtime number may be reduced to simulate slower user response time or increased to simulate faster user response time.

The script processor number and the aforementioned metric associated with the first computer apparatus may be used to determine the resources of the first computer apparatus consumed by the script. In one example, the resource consumption may be represented by a script score. The script score may be calculated by multiplying the metric associated with the first computer apparatus by the script processor number. Once again, the metric associated with the first computer apparatus may be 45 points/second. Thus, in the example discussed above, the script score would be 45 points/second×10 seconds=450 points/per second.

Referring back to FIG. 3, a metric associated with a second computer apparatus may be determined, as shown in block 304. As noted above, a test engineer may be allowed to select a model of a computer apparatus from a drop down box on a screen. The selected computer model may be a model the test engineer is contemplating to use for load testing. The metric may be obtained from a benchmark standard-setting entity, such as www.spec.orq. Referring back to the example of FIG. 2, a user may select the “HP DL 120 G5” model from the drop down box to determine how that particular model would handle a load test. A metric associated with the chosen computer apparatus model (e.g., the second computer apparatus) may be obtained from the benchmark standard-setting entity. The metric may be calculated in a variety of ways. For example, the benchmark standard-setting entity may calculate the metric associated with the second computer apparatus the same way the metric associated with the first computer apparatus (e.g., computer apparatus 100) is determined. Thus, the metric of the second apparatus may also be a standard benchmark number divided by a machine benchmark number associated with the second computer apparatus. The machine benchmark number associated with the second computer apparatus may also represent a length of time that the processor of the second computer apparatus took to execute a benchmark program. A benchmark standard-setting entity may provide that the metric associated with the “HP DL 120 G5” model is 1000 points 66 seconds=15 points/second.

Furthermore, drop down box 202 may also allow the user to select his or her local computer for capacity planning. In this example, the first computer apparatus and the second computer apparatus would be the same, and the metric associated with the first computer apparatus would be the same as the metric associated with the second computer apparatus. As such, there would be no need to download metric information from a benchmark standard-setting entity, when a user selects his or her local computer.

Referring back to FIG. 3, a number of instances of the computer executable instructions capable of executing concurrently in the second computer apparatus may be determined, as shown in block 306. In one example, such determination may be made, at least partially, using the illustrative values discussed above. As shown above, the resources of the first computer apparatus consumed by the script may be represented by a script score. The script score may be calculated by multiplying the metric associated with the first computer apparatus and the script processor number. Once again, the example script score discussed above may be the following:

script score=metric associated with the first computer×script processor number script score=45 points/second×10 seconds=450 points/second

As noted above, the script processor number may represent the time spent by the script using the processor of the first computer apparatus (e.g., computer apparatus 100). Assuming the metric associated with the first computer apparatus is 45 points/second and the script processor number is 10 seconds, the script score is 450 points/second. The number of instances of the computer executable instructions capable of executing concurrently in the second computer apparatus may be further determined by multiplying the metric of the second computer apparatus and the script runtime number associated with the first computer apparatus. Using the illustrative values discussed above, the product of the metric associated with the second computer apparatus and the script runtime number, may be the following:

Metric associated with second computer apparatus×script runtime number 15 points/second×200 seconds=3000 points/second

Multiplying the example metric obtained from the benchmark standard-setting entity for model “HP DL 120 G5” and the script runtime number associated with computer apparatus 100 results in 3000 points/second. This product may be divided by the script score calculated earlier:

3000 points/second÷450 points/second˜6.666

This may be rounded down to 6. Thus, the second computer apparatus (e.g., the computer model “HP DL 120 G5” chosen by the user from the drop down box) can execute approximately 6 instances of script 118 concurrently.

Referring now to FIG. 5, another illustrative screen shot is depicted. The screen shot shown in FIG. 5 illustrates a dialog box 502 that displays an estimate of the number of scripts that may execute concurrently in the computer apparatus model chosen from drop down box 202. A test engineer may use this information to determine whether the model selected from drop down box 202 is suitable for a particular load test or to determine how many computers of the selected model should be purchased.

Conclusion:

Advantageously, the above-described computer apparatus, non-transitory computer readable medium, and method allow test engineers to better prepare for a particular load test. In this regard, the user may be able to predict how a particular computer would behave in a load test environment before purchasing the said computer. In turn, load test execution can be carried out in a more organized fashion.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, processes may be performed in a different order or concurrently and steps may be added or omitted.

1. A system for load test capacity planning, the system comprising a first computer apparatus having a processor to:
determine resources of the first computer apparatus that are consumed by computer executable instructions when executed therein;
determine a metric associated with a second computer apparatus; and
determine a number of instances of the computer executable instructions that are able to execute concurrently in the second computer apparatus, the number being at least partially based on the metric associated with the second computer apparatus and the resources of the first computer apparatus that are consumed by the computer executable instructions.

2. The system of claim 1, wherein the metric associated with the second computer apparatus is obtained from a benchmark standard-setting entity.

3. The system of claim 1, wherein the computer executable instructions are contained in a script, the computer executable instructions being instructions to simulate a user interacting with another computer program.

4. The system of claim 3, wherein the processor is a processor to determine a metric associated with the first computer apparatus, the metric associated with the first computer apparatus being a standard benchmark number divided by a machine benchmark number, the machine benchmark number representing a length of time that the processor of the first computer apparatus takes to execute a benchmark program.

5. The system of claim 4, wherein to determine the resources of the first computer apparatus that are consumed by the computer executable instructions when executed therein, the processor is a processor to multiply the metric associated with the first computer apparatus and a script processor number so as to generate a script score, the script processor number representing time spent by the script using the processor of the first computer apparatus.

6. The system of claim 5, wherein to determine the number of instances of the computer executable instructions able to execute concurrently in the second computer apparatus, the processor is a processor to:
multiply the metric associated with the second computer apparatus by a script runtime number so as to generate a product, the script runtime number representing a length of time the script takes to complete execution in the first computer apparatus; and
divide the product by said script score.

7. The system of claim 6, wherein the processor is a processor to adjust the script runtime number in accordance with a delay pattern encoded in the script, the delay pattern being idle time recorded in the script that simulates a user being idle while interacting with the computer program.

8. The system of claim 4, wherein the standard benchmark number is one thousand.

9. A non-transitory computer-readable medium having instructions therein for load test capacity planning, the instructions, if executed, cause a processor of a first computer apparatus to:
determine a metric associated with the first computer apparatus;
utilize the metric associated with the first computer apparatus to determine resources thereof that are consumed by a script when executed therein, the script having computer executable instructions to simulate a user interacting with a computer program;
obtain a metric associated with a second computer apparatus, the metric associated with the second computer apparatus being obtained from a benchmark standard-setting entity; and
determine a number of instances of the script that are able to execute concurrently in the second computer apparatus, the number being at least partially based on the metric associated with the second computer apparatus and the resources of the first computer apparatus that are consumed by the script.

10. The non-transitory computer-readable medium of claim 9, wherein the metric associated with the first computer apparatus is a standard benchmark number divided by a machine benchmark number associated with the first computer apparatus, the machine benchmark number representing a length of time that the processor of the first computer apparatus takes to execute a benchmark program.

11. The non-transitory computer-readable medium of claim 10, wherein the standard benchmark number is one thousand.

12. The non-transitory computer-readable medium of claim 9, wherein the instructions therein, if executed, further cause a processor to multiply the metric associated with the first computer apparatus and a script processor number so as to generate a script score in order to determine the resources of the first computer apparatus that are consumed by the script when executed therein, the script processor number representing time spent by the script using the processor of the first computer apparatus.

13. The non-transitory computer-readable medium of claim 12, wherein, to determine the number of instances of the computer executable instructions able to execute concurrently in the second computer apparatus, the instructions in the non-transitory computer-readable medium, if executed, further cause a processor to:
multiply the metric associated with the second computer apparatus by a script runtime number so as to generate a product, the script runtime number representing a length of time the script takes to complete execution in the first computer apparatus; and
divide the product by the script score.

14. The non-transitory computer-readable medium of claim 13, wherein the instructions therein, if executed, further cause a processor to adjust the script runtime number in accordance with a delay pattern encoded in the script, the delay pattern being idle time recorded in the script that simulates a user being idle while interacting with the computer program.

15. A method for load test capacity planning, the method comprising:
executing, using a processor of a first computer apparatus, a script in the first computer apparatus so as to determine a script processor number and a script runtime number, the script having computer executable instructions to simulate a user interacting with a computer program, the script processor number representing time spent by the script using the processor, the script runtime number representing a length of time the script takes to complete execution in the first computer apparatus;
dividing, using the processor, a metric associated with the first computer apparatus by the script processor number so as to determine a script score, the script score representing resources of the first computer apparatus that are consumed by the script;
obtaining, using the processor, a metric associated with a second computer apparatus, the metric associated with the second computer apparatus being obtained from a benchmark standard-setting entity; and
determining, using the processor, a number of instances of the script that are able to execute concurrently in the second computer apparatus, the number being at least partially based on the metric associated with the second computer apparatus and the script score.

16. The method of claim 15, wherein determining the number of instances of the script to execute concurrently in the second computer apparatus further comprises:
multiplying, using the processor, the metric associated with the second computer apparatus by the script runtime number so as to generate a product; and
dividing, using the processor, the product by the script score.

17. The method of claim 15, further comprising adjusting, using the processor, the script runtime number in accordance with a delay pattern encoded in the script, the delay pattern being idle time recorded in the script that simulates a user being idle while interacting with the computer program.

18. The method of claim 15, wherein the metric associated with the first computer apparatus is a standard benchmark number divided by a machine benchmark number associated with the first computer apparatus, the machine benchmark number representing a length of time that the processor of the first computer apparatus takes to execute a benchmark program.

19. The method of claim 18, wherein the standard benchmark number is one thousand.
